(19) United States
(12) Patent Application Publication
(10) Pub. No.: US 2016/0207626 A1
(43) Pub. Date: Jul. 21, 2016

(54) Airborne Surveillance Kite

(71) Applicant: Glen R. Bailey, Scottsdale, AZ (US)

(72) Inventor: Glen R. Bailey, Scottsdale, AZ (US)

(21) Appl. No.: 15/002,612

(22) Filed: Jan. 21, 2016

Related U.S. Application Data
(60) Provisional application No. 62/105,964, filed on Jan. 21, 2015.

(51) Int. Cl. B64C 39/02; B64F 3/02; B64C 3/00; B64C 27/08; B64D 17/00; B64D 27/24; B64C 27/06

(52) U.S. Cl. CPC B64C 39/022; B64D 27/24; B64F 3/02; B64C 27/06; B64C 27/08; B64D 17/00; B64C 3/00; B64C 2201/127; B64C 2201/165; B64C 2201/148

(57) ABSTRACT

A deployable airborne surveillance kite for flying in a wind over a surface includes a wing, a tail, and a spar coupling the wing to the tail. The kite further includes a thrust rotor mounted to the kite in a vertical orientation for providing vertical lift to the kite. A tether assembly extends from the kite to the surface and couples the kite to the surface providing downward resistance in opposition to the vertical lift provided by the thrust rotor.

### CROSS-REFERENCE TO RELATED APPLICATIONS

This application claims the benefit of U.S. Provisional Application No. 62/105,964, filed Jan. 21, 2015, which is hereby incorporated by reference.

### FIELD OF THE INVENTION

The present invention relates generally to surveillance systems, and more particularly to airborne surveillance systems.

### BACKGROUND OF THE INVENTION

There are a variety of solutions for providing visual, radar, or other surveillance of an area. Unmanned aerial vehicles (“UAVs”) provide a highly mobile, versatile platform for airborne sensors. They can be operated from large offset distances to remain covert and provide access to a very wide area of surveillance coverage. However, UAVs require a large support staff to operate and are not particularly well suited for small surveillance areas given the time and cost requirements in maintaining and operating them. Further, fixed-wing UAVs can loiter only by circling an area, and single- and multi-copter UAVs have short flight times. UAVs have to land periodically to refuel. UAVs also require FAA certification to operate within the US and may require similar certifications for operation in foreign airspace.

Aerostats present another surveillance option. An aerostat is a lighter-than-air balloon that creates lift through the use of a buoyant gas. Aerostats can be tethered or free-flying, but usually the term “aerostat” refers to a stationary, tethered balloon. Aerostats have one or more gasbags which are lightweight skins containing a lifting gas to provide buoyancy. Gondolas containing equipment or people can be attached to the gasbags or an outer envelope covering the gasbags. Aerostats are suitable for observation, for carrying instrumentation or communications equipment, and for surveillance and reconnaissance. Aerostats have drawbacks, however. The lifting gas helium is a dwindling rarity and is extremely expensive. Aerostats can only be launched, flown, or brought down in limited wind conditions, demanding careful monitoring and accurate weather prediction. Aerostats tend to lose buoyancy with time as gas permeates the balloon skin or escapes through leaks, requiring the aerostat to be brought down and the gas to be replaced. Aerostats demand a large ground crew to launch and recover the balloon, and a great deal of time to do so. The balloon must face into the wind for stabilization. The aerostat can break free from the tether if deployed in high wind conditions. In addition, aerostats are vulnerable to strong winds, powerful downdrafts, lightning, rain, and snow.

Towers provide a simple and cost effective way of raising sensors above the ground. Towers are typically of a metal truss construction that supports the surveillance equipment. They are available both as mobile or fixed systems. Mobile towers are limited to heights of around 100 feet and require some form of power to raise and lower the tower. Fixed towers require extensive site preparation to erect and ensure stability, including the addition of guy wires and base structure to support the tower and the sensors. Further, fixed towers are limited to surveillance of only the local area where installed. An improved surveillance system is needed.

### SUMMARY OF THE INVENTION

A deployable airborne surveillance kite for flying in a wind over a surface includes a wing, a tail, and a spar coupling the wing to the tail. The kite further includes a thrust rotor mounted to the kite in a vertical orientation for providing vertical lift to the kite. A tether assembly extends from the kite to the surface and couples the kite to the surface providing downward resistance in opposition to the vertical lift provided by the thrust rotor.

### BRIEF DESCRIPTION OF THE DRAWINGS

Referring to the drawings:

FIG. 1 is a generalized, side elevation view of an airborne surveillance kite;

FIG. 2 is a top perspective view of the kite of FIG. 1;

FIGS. 3A-3C are side elevation views of the kite of FIG. 1 in various orientations in different wind conditions;

FIGS. 4 and 5 are top and bottom perspective views, respectively, of an airborne surveillance kite;

FIGS. 6A and 6B are section views of the kite of FIG. 4 taken along the line 6-6 in FIG. 4;

FIG. 6C is a section view of a tail of the kite of FIG. 4 taken along the line 6-6 in FIG. 4; and

FIGS. 7 and 8 are top and bottom perspective views, respectively, of an airborne surveillance kite.

### DETAILED DESCRIPTION

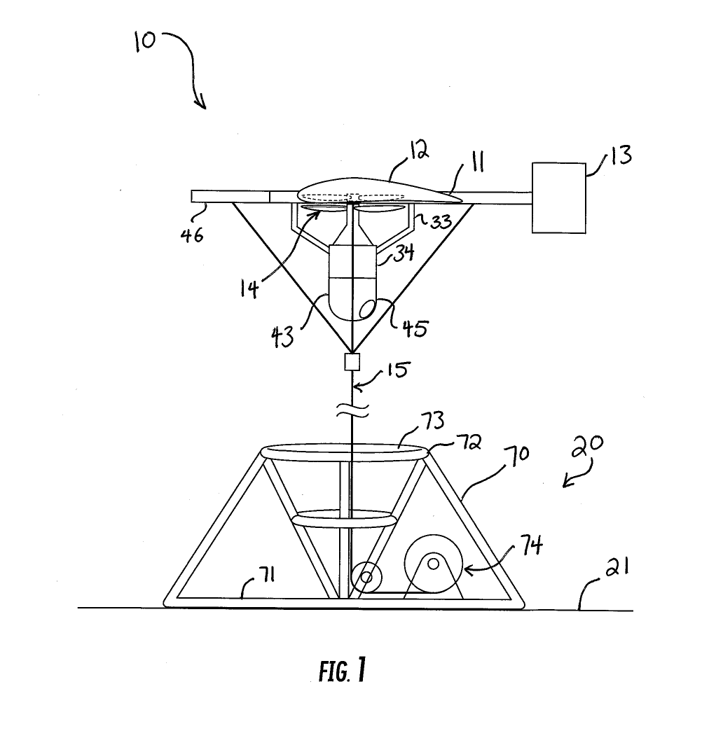

Reference now is made to the drawings, in which the same reference characters are used throughout the different figures to designate the same elements. FIG. 1 is a generalized side elevation view of a deployable, airborne surveillance system referred to as a “kite” 10. As shown throughout the drawings, the kite 10 is a tethered airborne surveillance system for providing remote surveillance of an area from a range of heights by collecting a variety of information and communicating such information to a receiver such as a ground base. Very basically, the kite 10 includes a framework 11, a large fixed wing 12, a tail 13, and a propeller assembly 14 providing vertical lift to the kite 10. The kite 10 is coupled, via a tether assembly 15, to a secure base or dock 20 to fix the kite 10 to a location 21 for surveillance of the location 21 and areas around the location 21. FIG. 1 shows kite 10 in a scale of its own, but not to scale with the dock 20. Additionally, the ether 15 is foreshortened to fit on the page. This is for clarity of the illustration and the accompanying description.

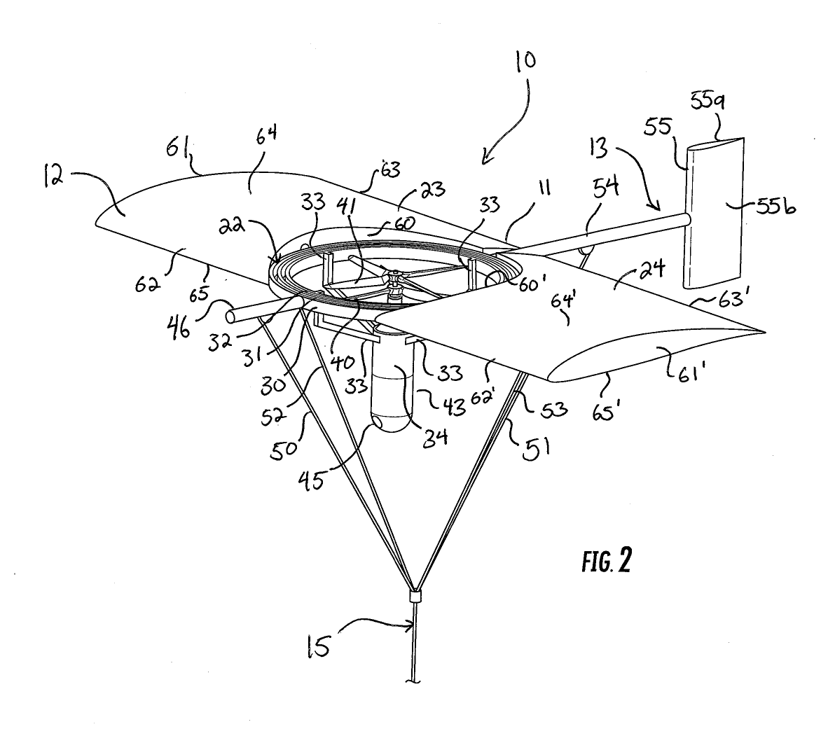

FIG. 2 shows the kite 10 in greater detail in a top perspective view. The various structural elements and features of the kite 10 can be seen more clearly than in FIG. 1. The framework 11 of the kite 10 includes a central gimbal 22 from which two opposed sides 23 and 24 of the wing 12 extend laterally. The gimbal 22 is a mechanized, two-axis gimbal, and includes drive motors at the mounting bearings. The drive motors are controlled electronically through programmable logic carried onboard the kite 10, which logic is controlled preferably by an autopilot program or by a remote operator coupled in wired communication through the tether assembly 15. The two-axis gimbal 22 includes an outermost fixed ring 30 to which the sides 23 and 24 of the wing 12 are rigidly mounted and which does not move out of the plane of the wing 12. Just inside the outermost fixed ring 30, the gimbal 22 has a concentric, outer gimbal ring 31 mounted for pivotal movement to the outermost fixed ring 30, and a concentric, inner gimbal ring 32 mounted for pivotal movement to the outer gimbal ring 31. The outer gimbal ring 31 includes pivot points spaced apart and on either side of the wing 12, mounting the outer gimbal ring 31 to the outermost fixed ring 30 for aeronautical pitch. The inner gimbal ring 32 includes pivot points spaced apart and between the two sides 23 and 24 of the wing 12, mounting the inner gimbal ring 32 to the outer gimbal ring 31 for aeronautical roll.

Four strong, angled, lightweight, and rigid struts 33 extend inwardly to a motor unit 34 located below the wing 12, centrally within the gimbal 22. The struts 33 are spaced evenly apart circumferentially. The struts 33 hold the motor unit 34 in a low position so that two sets of thrust rotors or propellers 40 and 41, mounted coaxially on a rotor shaft 42, are generally level with the plane of the wing 12. The propellers 40 and 41 are preferably contra-rotating propellers 40 and 41: each rotates in a different direction to maintain stability of the kite 10 and prevent adverse yaw effects on the kite 10. The propellers 40 and 41 are generally level with the wing 12 to allow air to flow over the wing 12 and to prevent the propellers 40 and 41 from blowing air down onto the wing 12.

The kite 10 is equipped with a payload 43. The payload 43 is mounted to a bottom of the motor unit 34 and contains or preferably is a piece of surveillance equipment, such as photo, infrared, radar, lidar, or acoustic sensors, or other like surveillance equipment. FIG. 2 illustrates an embodiment in which the payload 43 is contained within a generally cylindrical housing with an inverted dome having a downwardly-angled lens 45, through which the eye of a high-definition visible-light camera is directed to monitor a field of view of the location 21 below the kite 10.

The payload 43 can be quite heavy, and so the kite 10 is constructed with materials providing great strength to weight characteristics, and with a design providing great strength. The framework includes a forwardly-directed spar or sprit 46 which is attached to and extends forwardly from the outermost fixed ring 30 of the gimbal 22. The sprit 46 is rigidly and securely fixed to the outermost fixed ring 30 and is generally parallel to the wing 12. The sprit 46 provides a forward location at which a portion of the tether assembly 15 is fixed, providing improved pitch response and accuracy than a location more to the rear. Briefly, it is noted that the relative directions “forward” and “rearward,” and grammatical variations thereof, are used throughout this description to indicate relative positioning of a structural element or features or relative alignment of structural elements or features. Similarly, “lateral” and grammatical variations thereof indicate relative positioning with respect to the forward and rearward directions or left and right directions. Finally, “up” and “down”, and grammatical variations thereof, indicate relative directions, namely, away from the ground location 21 and toward the ground location 21. The sprit 46 is a short, rigid protection such as a hollow pole. A forward lead 50 of the tether assembly extends from the sprit 46. The forward lead 50 passes into a hole in the sprit 46, about a pulley, and is secured within the framework 11 to a pitch adjustment assembly in the framework for shortening and lengthening the forward lead 50. The tether assembly 15 and pitch adjustment assembly are explained in greater detail later. The pitch adjustment assembly is explained with respect to an alternate embodiment; however, the pitch adjustment assembly is structured and operates in an identical manner, as one having ordinary skill in the art will appreciate upon reading its description with respect to that alternate embodiment.

The tail 13 of the kite 10 includes a rearwardly-directed spar 54 extending from the outermost fixed ring 30 of the gimbal 22, to which the spar 54 is rigidly and securely fixed. The spar 54 is a long, preferably hollow pole, extending between the gimbal 22 and a fin 55. The fin 55 has a generally symmetric airfoil shape and is oriented with its long axis arranged vertically so that opposed faces 55a and 55b of the airfoil are directed laterally. The fin 55 is preferably fixed at the rearward terminal end of the spar 54. The fin 55, disposed at the rearward end of the kite 10, serves to maintain the kite 10 in forward alignment with the sprit 46 pointed into the wind and the kite 10 parallel to the wind. In some embodiments, the fin 55 is mounted for pivotal movement to assist in maneuvering the kite 10, which is especially helpful during raising, lowering, and high-wind situations.

A rear lead 51 of the tether assembly 15 is coupled to the spar 54. The lead 51 extends into the spar 54 and is secured within the spar 54 to the same pitch adjustment assembly that the forward lead 50 to which the forward lead is secured, for shortening and lengthening the rear lead 51. The rear lead 51 is operated in cooperation with the forward lead 50 to affect the pitch and lift of the kite 10.

In the embodiment shown in FIG. 1-3C, the wing 12 appears as a single wing but is in fact severed into the opposed sides 23 and 24. The sides 23 and 24 are opposite and identical, and as such, the same reference characters will be used to describe each. The side 23 has an inner end 60, an opposed outer end 61, and opposed leading and trailing edges 62 and 63 extending therebetween. The side 23 further includes an upper surface 64 and a lower surface 65. The side 23 has an airfoil shape, such that the curve of the side 23 between the leading edge 62 and the trailing edge 63 causes air to move faster over the upper surface 64 than the lower surface 65, and the trailing edge 63 is directed downward, causing air to be moved downwards from the side 23, thereby creating lower air pressure at the upper surface 64 than at the lower surface 65 and creating lift on the side 23 of the wing 12. The inner end 60 of the side 23 is arcuate and conforms to the circular shape of the outermost fixed ring 30 of the gimbal 22, such that there is only a small gap between the outermost fixed ring 30 and the side 23 of the wing. The side 23 is fixed to the outermost fixed ring 30 and maintains its generally parallel alignment with the outermost fixed ring 30. A side lead 52 is coupled to the lower surface 65 of the side 23, and is fixed and not mounted for adjustment.

As mentioned above, the sides 23 and 24 are opposite and identical. Accordingly, the structural elements and features of the side 24 are marked with the same reference characters as those of the side 23, but are designated with a prime (“′”) symbol to differentiate them from the structural elements and features of the side 23. As such, the side 24 includes an inner end 60′, an opposed outer end 61′, opposed leading and trailing edges 62′ and 63′, and upper and lower surfaces 64′ and 65′. The side 24 has the same aerodynamic behavior as the side 23. A side lead 53 is coupled to the lower surface 65′ of the side 24, and is fixed and not mounted for adjustment.

In operation, the kite 10 is flown above a location 21 to be monitored. The location 21 can be quite large or very defined and specific. The kite 10 is flown at an altitude commensurate to the characteristics of the location 21 and the surveillance needs. For instance, if a large location 21 is to be monitored, flying the kite 10 higher may make available a wider field of view covering a greater area. A greater flight altitude may also provide greater protection to the height, such as from enemy weapons. A lower altitude may be advantageous to use when greater detail is needed in surveillance and secrecy or safety and integrity of the kite 10 are not of issue. Further, the kite 10 is flown at an altitude where the winds can support the kite 10, either fully or with the assistance of the propellers 40 and 41.

The kite 10 is launched from the dock 20. Referring back to FIG. 1, the dock 20 includes a rigid, strong, durable structural framework 70 having a base 71 secured to the ground and an opposed top 72 formed with a seat 73 size to receive the kite 10 when the kite 10 is docked and grounded. The top 72 consists of an opening sized to correspond with the framework 11 of the kite 10 so that the framework 11, especially the struts 33, rests on the top 72 and the seat 73 receives the motor unit 34 and the payload 43 below the motor unit 34, maintaining all parts of the kite 10 above ground to prevent contact and damage with ground. A spool assembly 74 carried in the framework 70 winds and unwinds the tether assembly 15 to let out additional length of the tether assembly 15 when the kite 10 is flown and to reel in length of the tether assembly 15 when the kite 10 is lowered. The spool assembly 74 includes a strong winding spool, a motor coupled to the spool to drive the spool, and preferably a strong pulley located proximate to a center of the framework aligned with a center of the seat 73, so that the tether assembly 15 extends out of the framework 70 in a generally intermediate location with respect to the seat 73 and the framework 70. The dock is preferably constructed from steel, or some other material providing extreme strength and rigidity, and which resists both tension and compression.

Referring to FIG. 2, to fly the kite 10, power is provided to the motor unit 34 to rotate the propellers 40 and 41. The tether assembly 15 carries power to the motor unit 34 of the kite 10; it is a combination of several cables. The tether assembly 15 includes power cables, such as a set of primary cables and a set of secondary cables providing redundancy to the primary cables. The primary cables preferably include a positive (or “hot”) cables, a negative (or “cold”) cable, and a grounding cable. The secondary cables preferably also include positive and negative cables. Power is provided through the primary cables, and then through the secondary cables in the event that an issue or malfunction arises with the primary cables. The tether assembly also includes sets of data communication cables, which in different embodiments are uni- and bi-directional, to allow instructional and control data to be passed to the programmable logic on the kite 10 and to receive operational, positional, surveillance, and other information from the kite 10. These sets of data communication cables provide redundancy for data communication. The data communication cables are electrical, radio-frequency, ethernet, fiber optic, or other like communication cables.

Power is thus provided through the tether assembly 15 to energize the motor unit 34 and drive the propellers 40 and 41. As the propellers 40 and 41 rotate faster and faster, the kite 10 begins to lift. The propellers 40 and 41 provide the lift initially. As the kite 10 rises higher, the wing 12 begins to provide some lifting force as the kite 10 enters progressively more wind. Initially, though, the propellers 40 and 41 must provide all or substantially all of the lifting force. Frequently during raising of the kite 10, both the lift of the wing 12 and thrust of the propellers 40 and 41 is relied on. The operator or the autopilot controls the pitch of the kite 10 (as will be explained later), in cooperation with the speed of the motor unit 34, to raise the kite 10 at a desired speed. The kite 10 rises to a desired altitude, which could be as high as several thousand feet. FAA certification is not required for aerial devices which are tethered to the ground as they are not considered UAVs; this eases the processes of flying the kite 10 and of the repeated raising and lowering of the kite 10. The kite 10 may require an

FAA waiver depending on the altitude at which the kite 10 is intended to be flown.

Once the kite 10 has reached the altitude selected for the particular surveillance operation, the spool assembly 74 stops unwinding and holds the unwound length of the tether assembly steady. The lifting force on the kite 10 is usually approximately equal to the downward force on the kite 10 applied by the tether assembly 15, and the kite 10 thus maintains this selected altitude. As during the raising process, the lifting force on the kite 10 is affected both by the wind and the propellers and 41. The operator, or more preferably the autopilot, monitors and adjusts the pitch of the kite 10 and the speed of the motor unit 34 to maintain the altitude.

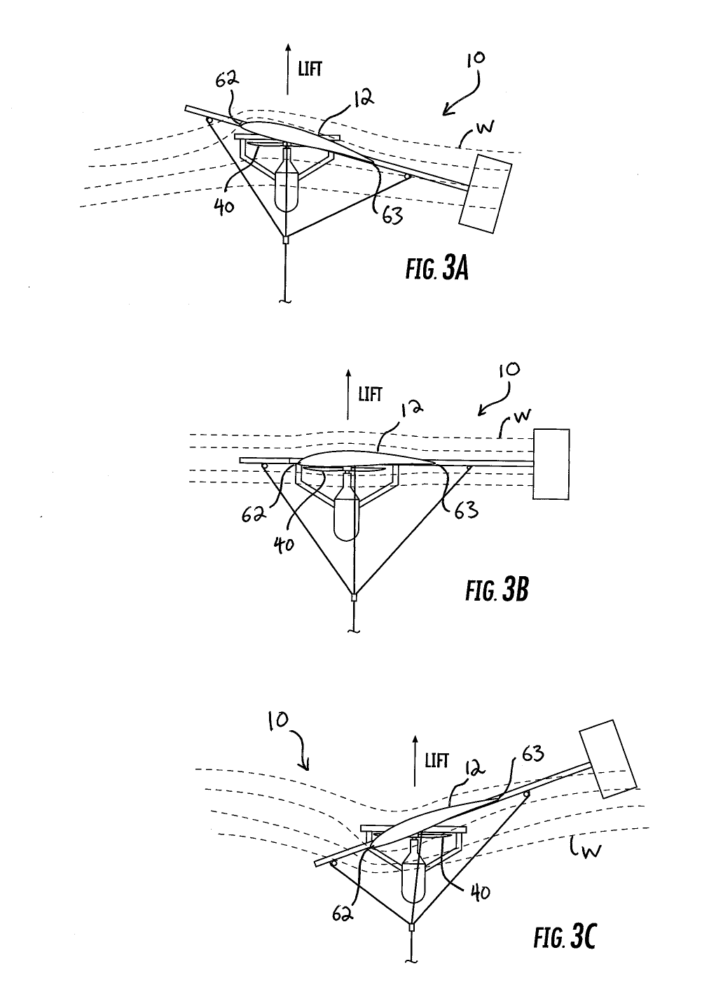

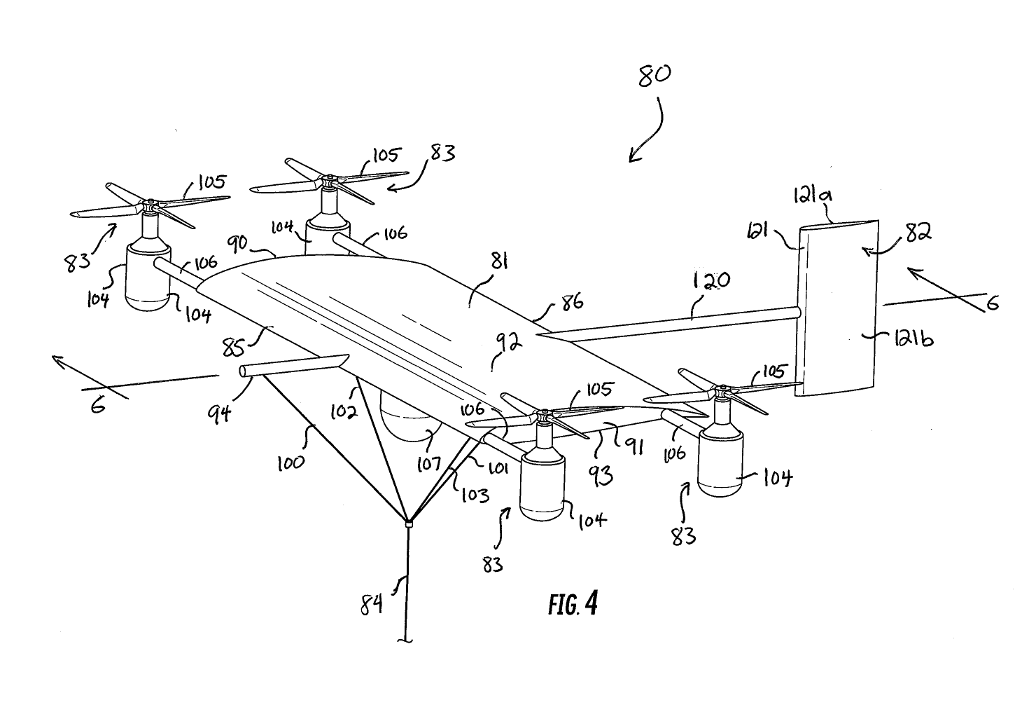

Referring now to FIGS. 3A-3C, the kite 10 is shown as it would appear in a wide range of pitches. FIG. 3A illustrates an exemplary nose-up orientation of the kite 10, in which the leading edge 62 of the wing 12 is higher than the trailing edge 63 with respect to the wind, the pathlines of which are marked with the reference character W and show the direction of the wind. FIG. 3B illustrates an exemplary level orientation of the kite 10, in which the leading edge 62 of the kite 10 is aligned with the trailing edge 63 with respect to the wind W. Finally, FIG. 3C illustrates an exemplary nose-down orientation of the kite 10, in which the leading edge 62 is lower than the trailing edge 63 with respect to the wind.

While the nose-up orientation does not necessarily produce a positive lifting force, the nose-up orientation does generally produce a greater lifting force than the level orientation, which similarly produces a greater lifting force than the nose-down orientation. Typically, the nose-up orientation is used to raise the kite 10, and the nose-down orientation is used to lower the kite 10. All three of the nose-up, level, and nose-down orientations are used while the kite 10 is flying at a desired altitude, in order to maintain such desired altitude with the least amount of energy consumed by the motor unit 34. The operator, or more preferably, the autopilot, adjusts the pitch of the kite 10 to position the wing 12 in the wind W as necessary to maintain the altitude. Preferably, the pitch of the kite 10 is adjusted so as to minimize the use of the propellers 40 and 41.

The forward lead 50 is adjusted in cooperation with the rear lead 51 to pitch the kite 10. Load cells on the forward and rear leads 50 and 51 monitor the tension on the forward and rear leads 50 and 51. If additional lifting force is needed, the pitch adjustment assembly lengthens the forward lead 50 and shortens the rear lead 51 to pitch the kite 10 into the nose-up orientation. If less lifting force is needed, the pitch adjustment assembly shortens the forward lead 50 and lengthens the rear lead 51 to pitch the kite 10 into the nose-down orientation. If the kite 10 needs much more lifting force in any orientation, the autopilot energizes the motor unit 34 to rotate—or rotate faster—the propellers 40 and 41 to provide the additional lifting force.

When the kite 10 needs to be brought back down to the ground, such as may be required for service, the speed of descent of the kite 10 is controlled by the operator or autopilot, by rotating the propellers 40 and 41 so as to maintain a generally constant tension on the tether assembly 15 as the tether assembly 15 is wound back into the spool assembly 74. The kite 10 then lowers into the dock 20, with the framework 11 of the kite 10 resting on the top 72 of the dock 20 and the motor unit 34 and payload 43 within the seat 73.

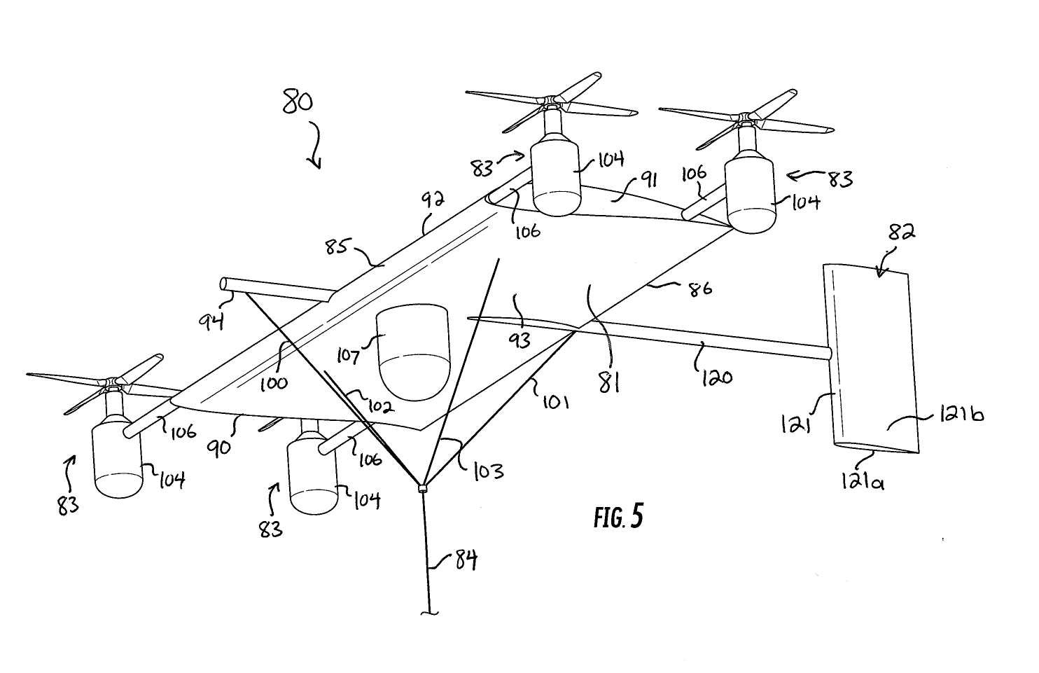

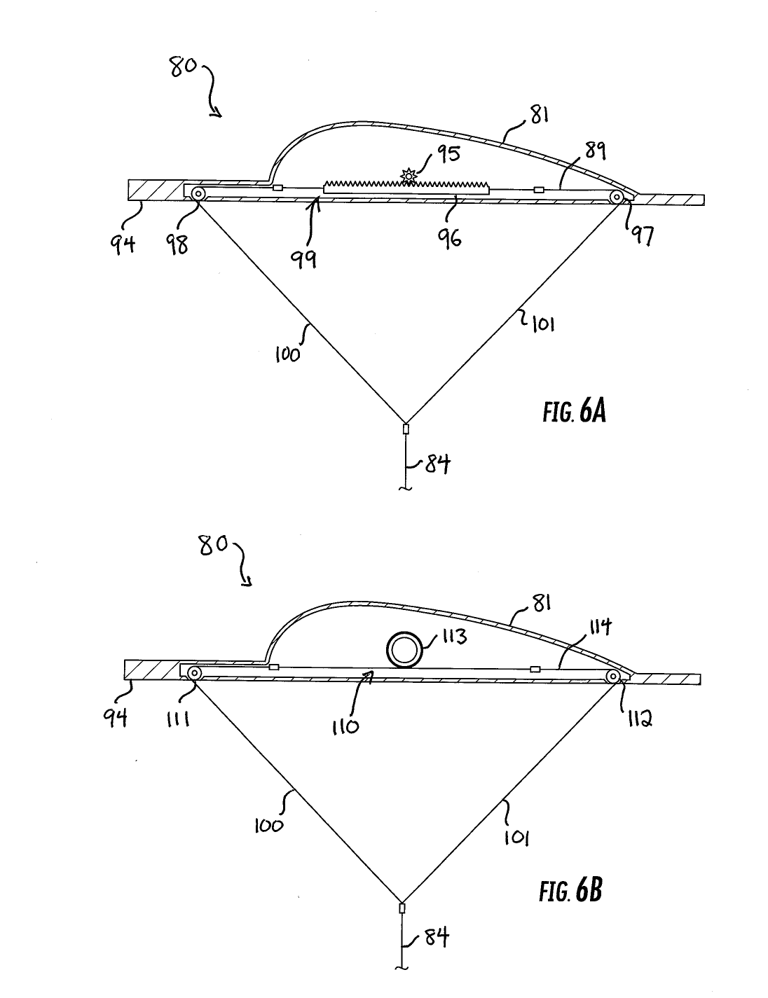

Another embodiment of the kite is shown in FIGS. 4 and 5 and is marked with the reference character 80. The kite 80 has many structural elements and features similar to those of the kite 10. The kite 80 includes a wing 81 which extends the full width of the kite 80, a tail 82, and four propeller assemblies 83. The kite 80 is coupled, via a tether assembly 84, to a secure dock to fix the kite 80 to a location. The dock is not shown in FIGS. 4 and 5 but is identical to the dock 20 in FIG. 1, and one having ordinary skill in the art will readily appreciate and understand the substitution.

The wing 81 is a single, unified, wide structure having an airfoil shape with a leading edge 85, a trailing edge 86, opposed ends 90 and 91, and opposed upper and lower surfaces 92 and 93. The curve of the wing 81 between the leading edge 85 and the trailing edge 86 causes air to move faster over the upper surface 92 than the lower surface 93, and the trailing edge 86 is directed downward, causing air to be moved downwards, thereby creating lower air pressure at the upper surface 92 than at the lower surface 93, and creating lift on the wing 81.

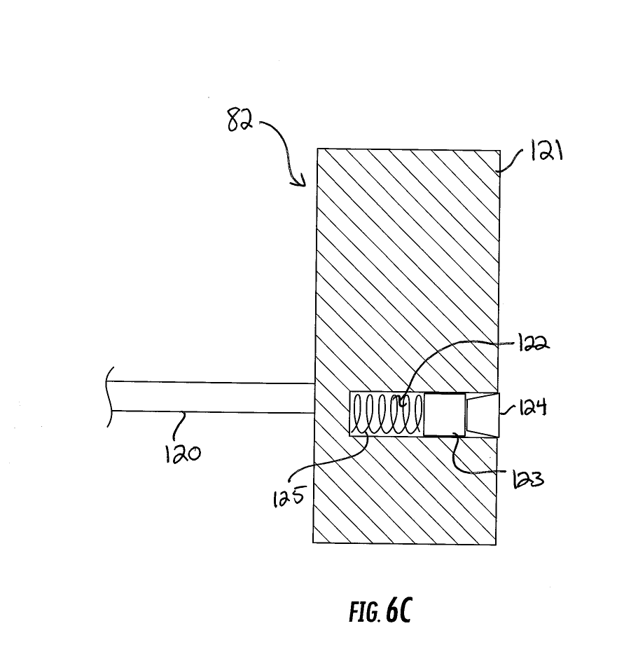

The wing 81 is rigid, and is preferably constructed with a monocoque construction from an array of ribs extending between the leading and trailing edges 85 and 86 and spaced apart between the opposed ends 90 and 91. The upper and lower surfaces 92 and 93 are skins, or a single skin, such as nylon, carbon fiber, aluminum, or some other lightweight material that may be stretched across the ribs to provide the overall structure with strength and rigidity. A forwardly-directed spar or sprit 94 extends forwardly from the leading edge 85 of the wing 81 at a location generally intermediate to the ends 90 and 91. The sprit 94 is a short, rigid projection such as a hollow pole. A forward lead 100 of the tether assembly 84 is coupled to the sprit 94 in front of the wing 81, while a rear lead 101 is coupled behind the wing 81. The forward lead 100 passes into a hole in the sprit 94, about a pulley, and is secured within the wing 81 to a pitch adjustment assembly 99, shown in FIG. 6A.

Turning to FIG. 6A, which is a section view taken along the line 6-6 in FIG. 4, the pitch adjustment assembly 99 is shown within a hollow in the monocoque body of the wing 81. The pitch adjustment assembly 99 includes a front pulley 98, an opposed rear pulley 97, a rack 96, and a pinion gear 95. The pinion gear is coupled to a drive motor, which in turn is coupled in electronic communication to the programmable logic onboard the kite 80 and also to power and data communication through the tether assembly 84 to a remote operator. The pinion gear 95 is in meshing engagement with the rack 96, which is secured on a central tie that is coupled to and extends between the forward lead 100 and the rear lead 101. The pinion gear 95 rotates in a first direction to move the rack 96 forward, and in another direction to move the rack 96 rearward. As described above with the embodiment of FIGS. 1-3C, the pitch adjustment assembly 99 lengthens the forward lead 100 and shortens the rear lead 101 to pitch the kite 80 into the nose-up orientation. If less lifting force is needed, the pitch adjustment assembly 99 shortens the forward lead 100 and lengthens the rear lead 101 to pitch the kite 80 into the nose-down orientation. The pitch adjustment assembly 99 thereby provides finely-tuned control of the pitch and lift on the kite 80.

An alternate embodiment of a pitch adjustment assembly 110 is shown in FIG. 6B. There, the pitch adjustment assembly includes a front pulley 111, an opposed rear pulley 112, a windlass 113, and a central tie 114 wrapped around the windlass 113. The windlass 113 is coupled to a drive motor, which in turn is coupled in electronic communication to the programmable logic onboard the kite 80 and also to power and data communication through the tether assembly 84 to a remote operator. The central tie 114 is wrapped around the windlass 113 several times to form a secure engagement. The central tie 114 is coupled to and extends between the forward lead 100 and the rear lead 101. The windlass 113 rotates in a first direction to move the central tie 114 forward, and in another direction to move the central tie 114 rearward, thereby imparting lengthening and shortening to the forward lead 100, respectively, and imparting shortening and lengthening to rear lead 101, respectively. The pitch adjustment assembly 110 lengthens the forward lead 100 and shortens the rear lead 101 to pitch the kite 80 into the nose-up orientation. If less lifting force is needed, the pitch adjustment assembly 110 shortens the forward lead 100 and lengthens the rear lead 101 to pitch the kite 80 into the nose-down orientation. The pitch adjustment assembly 110 thereby provides finely-tuned control of the pitch and lift on the kite 80.

Turning now to FIGS. 4 and 5, but also to FIG. 6C, the tail 82 of the kite 80 includes a rearwardly-directed spar 120 extending rearwardly from the trailing edge 86 of the wing 81. As partially seen in FIG. 5, the spar 120 preferably extends into the wing 81 and is secured within the wing 81 to an internal rib. The spar 120 is a long, preferably hollow pole, extending between the wing 81 and a fin 121. The fin 121 has a generally symmetric airfoil shape and is oriented with its long axis arranged vertically so that opposed faces 121a and 121b of the airfoil are directed laterally. The fin 121 is preferably fixed at the rearwardly terminal end of the spar 120. The fin 121, disposed at the rearward end of the kite 80, serves to maintain the kite 80 in forward alignment with the sprit 94 pointed into the wind and the kite 80 parallel to the wind. In some embodiments, the fin 121 is mounted for swinging movement to assist in maneuvering the kite 80, which is especially helpful during raising, lowering, and high-wind situations.

Between the opposed faces 121a and 121b, a void 122 is formed into the fin 121 from the trailing edge of the fin 121. A parachute 123 is stored in the void 122; the parachute 123 is highly packaged and compressed, and secured in place within the void 122 by a plug 124. The onboard logic on the kite 80 receives input from each of the propeller assemblies 83, accelerometers on the kite 80, information from the ground remote operator, and from the tether assembly 84 itself. Should an emergency situation be detected, such as if each propeller assembly 83 fails and the kite 80 begins to fall, the plug 124 is ejected and the parachute 123 is deployed, so that the heavy kite 80 is not destroyed on impact with the ground.

The rear lead 101 of the tether assembly 84 is coupled to the spar 120. The rear lead 101 extends into the spar 120 and is secured within the spar 120 about the pulley 97, and is then coupled to the central tie 89 of the pitch adjustment assembly 99, which is coupled in electronic communication to the programmable logic onboard the kite 80 and preferably responds to instructions from the autopilot program or the operator to control the pitch of the kite 80 with respect to the wind, and thereby control and affect the lift on the kite 80. The rear lead 101 is operated in cooperation with the forward lead 100 to affect the pitch and lift of the kite 80.

Side leads 102 and 103 are coupled to the lower surface 93 of the wing 81. The side leads 102 and 103 are spaced apart from each other on either side of a center of the wing 81. Each of the side leads 102 and 103 is fixed and is not mounted for adjustment.

The propeller assemblies 83 are mounted at four corners of the wing 81. Each propeller assembly 83 is identical in all aspects but location and operation, which will be described, and as such, the structure of only one propeller assembly 83 will be described here, with the understanding that the description applies equally to all of the propeller assemblies 83. The propeller assembly 83 includes a motor unit 104 and a thrust rotor or propeller 105. The motor unit 104 is directed upward, and the propeller 105 preferably has four blades. The propeller 105 is mounted on a rotor shaft of the motor unit 104. The propeller assembly 104 is carried apart from the wing 81, supported on a strut 106 extending from the wing 81 and fixed within the wring 81 to a rib. In the embodiments shown in FIGS. 4-5, the propeller assemblies 83 are located just off the corners of the wing 81, namely, one propeller assembly 83 is located off the corner between the leading edge 85 and the end 90, another propeller assembly 83 is located off the corner between the leading edge 85 and the end 91, yet another propeller assembly 83 is located off the corner between the trailing edge 86 and the end 90, and yet still another propeller assembly 83 is located off the corner between the trailing edge 86 and the end 91.

Each of the propeller assemblies 83 is independently controllable. The propeller assemblies 83 are rotated to orient the kite 80 as desired by the operator autopilot. For instance, to pitch the kite 80 into a nose-up orientation, the propeller assemblies 83 off the leading edge 85 are provided with more power than the propeller assemblies 83 off the trailing edge 86. Additionally, the propeller assemblies 83 may be rotated relative to the cord of the wing 81.

A payload 107 is mounted to the lower surface 93 of the wing 81 and is preferably secured to ribs within the wing 81. The payload 107 is a container or is preferably a piece of surveillance equipment, such as a photo, infrared, or other camera device, radar, acoustic sensors, or other like surveillance equipment.

The kite 80 is operated similarly to the kite 10, and as such, discussion of its operation does not bear repeating. The kite 80 docks with and is launched from a dock identical to the dock 20. The kite 80 performs similarly to the kite 10, though by controlling each of the propeller assemblies 83 rather than the central propeller assembly 14 of the kite 10. Some of the propeller assemblies 83 may be rotated in opposing directions to maintain yaw stability of the kite 80.

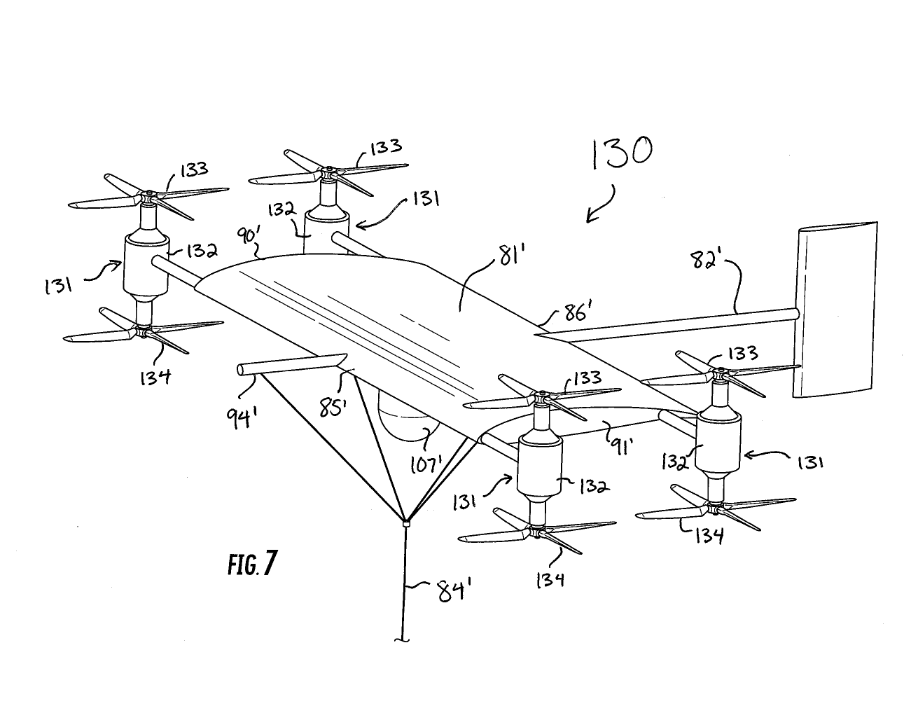

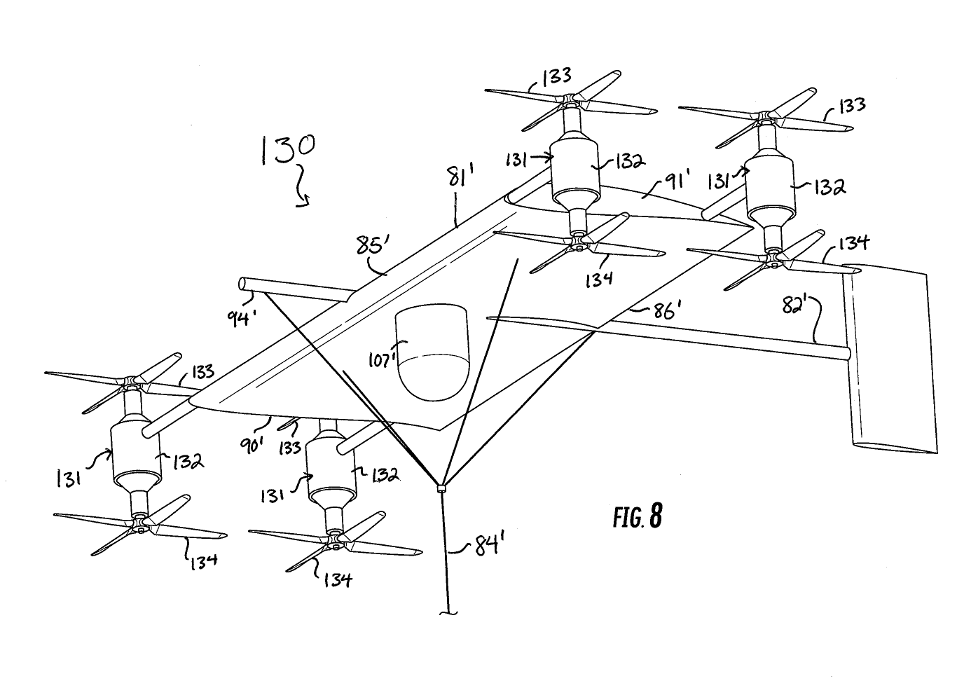

FIGS. 7 and 8 show an alternate embodiment of a kite 130. The kite 130 is identical to the kite 80 in every respect except as described herein. As such, reference characters used to identify the various structural elements and features of the kite 80 are used similarly to identify the various structural elements and features of the kite 130 but are marked with a prime (“′”) symbol to differentiate them from those of the kite 80. As such, the kite 130 includes a wing 81′, a tail 82′, a tether assembly 84′, a leading edge 85′, a trailing edge 86′, opposed ends 90′ and 91′, a sprit 94′, a payload 107′, as well as various other parts. The kite 130 includes four propeller assemblies 131 mounted at four corners of the wing 81′. Each propeller assembly 131 is identical to the others in all aspects but location and operation, which will be described, and as such, the structure of only one propeller assembly 131 will be described here, with the understanding that the description applies equally to all of the propeller assemblies 131. The propeller assembly 131 includes a motor unit 132 and an upper thrust rotor or propeller 133 and an opposed lower thrust rotor or propeller 134. The motor unit 132 includes two independently-driven shafts, one mounted upward for the upper propeller 133 and the other directed downward for the lower propeller 134. Each propeller 133 and 134 preferably has four blades. The propeller assembly 132 is carried apart from the wing 81′, supported on a strut 106′ extending from the wing 81′ and fixed within the wring 81′ to a rib. In the embodiments shown in FIGS. 7-8, the propeller assemblies 131 are located just off the corners of the wing 81′, namely, one propeller assembly 131 is located off the corner between the leading edge 85′ and the end 90′, another propeller assembly 131 is located off the corner between the leading edge 85′ and the end 91′, yet another propeller assembly 131 is located off the corner between the trailing edge 86′ and the end 90′, and yet still another propeller assembly 131 is located off the corner between the trailing edge 86′ and the end 91′.

During normal operation of the kite 130, only the upper propellers 133 of the propeller assemblies 131 operate, similarly to the propeller assemblies 83 of the kite 80. However, the motor units 132 of the propeller assemblies 131 are fit with a vibration sensor which detects unusual vibration that can indicate failure. Should a vibration sensor on a propeller assembly 131 detect failure, or lessening of power in a propeller assembly 131, the onboard logic on the kite 130 instructs the lower propeller 134 for that propeller assembly 131 to begin to rotate. The lower propellers 134 thus provide a redundant set of propellers to the upper propellers 133.

A preferred embodiment is fully and clearly described above so as to enable one having skill in the art to understand, make, and use the same. Those skilled in the art will recognize that modifications may be made to the described embodiment without departing from the spirit of the invention. To the extent that such modifications do not depart from the spirit of the invention, they are intended to be included within the scope thereof.

The invention claimed is:

1. A deployable kite for flying in a wind over a surface, the kite comprising:
a wing, a tail, and a spar coupling the wing to the tail;
a thrust rotor mounted to the kite in a vertical orientation for providing vertical lift to the kite; and
a tether assembly extending from the kite to the surface coupling the kite to the surface providing downward resistance in opposition to the vertical lift provided by the thrust rotor.

2. The kite of claim 1, wherein the thrust rotor is carried within the wing.

3. The kite of claim 1, wherein the thrust rotor is mounted to a gimbal.

4. The kite of claim 1, wherein the tether assembly includes:
a forward lead attached forward of the wing, and a rear lead attached under the wing; and
a pitch adjustment assembly coupled to the forward and rear leads to shorten the forward lead and lengthen the rear lead, and to lengthen the forward lead and shorten the rear lead.

5. The kite of claim 4, wherein:
the pitch adjustment assembly includes a rack and pinion disposed within the wing;
the forward and rear leads are secured to opposed ends of the rack; and
the pinion drives the rack forward and rearward to lengthen and shorten the forward and rear leads.

6. The kite of claim 4, wherein the pitch adjustment assembly includes:
a windlass disposed within the wing; and
a central tie coupled between the forward and rear leads and wrapped around the windlass so that rotation of the windlass imparts lengthening and shortening of the forward and rear leads.

7. The kite of claim 1, further comprising a parachute releasably stored in the tail.

8. The kite of claim 1, wherein the wing is of monocoque construction.

9. The kite of claim 1, further comprising:
a payload carried by the kite including surveillance equipment; and
power and data cables within the tether assembly to power and control the kite.

10. A deployable kite for flying in a wind over a surface, the kite comprising:
a wing, a tail, and a spar coupling the wing to the tail;
four thrust rotors mounted to the kite in a quadrotor arrangement about the wing, each mounted in a vertical orientation for providing independent vertical lift to the kite; and
a tether assembly extending from the kite to the surface coupling the kite to the surface providing downward resistance in opposition to the vertical lift provided by the thrust rotor.

11. The kite of claim 10, wherein each thrust rotor is carried offboard the wing.

12. The kite of claim 10, wherein each thrust rotor is mounted on a gimbal.

13. The kite of claim 10, wherein the tether assembly includes:
a forward lead attached forward of the wing, and a rear lead attached under the wing; and
a pitch adjustment assembly coupled to the forward and rear leads to shorten the forward lead and lengthen the rear lead, and to lengthen the forward lead and shorten the rear lead.

14. The kite of claim 13, wherein:
the pitch adjustment assembly includes a rack and pinion disposed within the wing;
the forward and rear leads are secured to opposed ends of the rack; and
the pinion drives the rack forward and rearward to lengthen and shorten the forward and rear leads.

15. The kite of claim 13, wherein the pitch adjustment assembly includes:
a windlass disposed within the wing; and
a central tie coupled between the forward and rear leads and wrapped around the windlass so that rotation of the windlass imparts lengthening and shortening of the forward and rear leads.

16. The kite of claim 10, further comprising a parachute releasably stored in the tail.

17. The kite of claim 10, wherein the wing is of monocoque construction.

18. The kite of claim 10, further comprising four secondary thrust rotors mounted to the kite in the quadrotor arrangement in a plane apart from the thrust rotors.

19. The kite of claim 18, further comprising:
a vibration sensor on each of the thrust rotors for detecting vibration in the respective thrust rotor; and
in response to one of the vibration sensors detecting vibration in the respective thrust rotor, one of the secondary thrust rotors corresponding to the respective thrust rotor is energized.

20. The kite of claim 10, further comprising:
a payload carried by the kite including surveillance equipment; and
power and data cables within the tether assembly to power and control the kite.
